(19) United States
(12) Patent Application Publication
(10) Pub. No.: US 2023/0054396 A1
(43) Pub. Date: Feb. 23, 2023

(54) SILANE GROUP-CONTAINING BRANCHED POLYMER

(71) Applicant: SIKA TECHNOLOGY AG, Baar (CH)

(72) Inventors: Andreas KRAMER, Zürich (CH); Marcel OERTLI, Winterthur (CH); Ursula STADELMANN, Zürich (CH); Sven REIMANN, Zürich (CH)

(73) Assignee: SIKA TECHNOLOGY AG, Baar (CH)

(21) Appl. No.: 17/792,794

(22) PCT Filed: Feb. 3, 2021
(86) PCT No.: PCT/EP2021/052560

§ 371 Date: Jul. 14, 2022

(30) Foreign Application Priority Data
Feb. 10, 2020 (EP) 20156461.4

(51) Int. Cl. C08G 18/75; C08G 18/10; C08G 18/28; C08G 18/48; C08G 18/76; C09J 175/08; C09D 175/08; C09K 3/10

(52) U.S. Cl. CPC C08G 18/755; C08G 18/10; C08G 18/289; C08G 18/4825; C08G 18/4841; C08G 18/7671; C09J 175/08; C09D 175/08; C09K 3/1021

(57) ABSTRACT

A branched polymer containing silane groups having an average of at least 2.1 silane groups per molecule, from the reaction of (i) a polymer containing isocyanate groups and having an NCO content ranging from 0.7% to 4% by weight, obtained from the reaction of at least one monomeric diisocyanate with at least one polyether polyol in a molar NCO/OH ratio of at least 1.5/1, (ii) with at least one amino-, mercapto- or hydroxysilane, in a stoichiometric ratio of at least 1 mol of amino-, mercapto- or hydroxysilane per molar equivalent of isocyanate groups. The polymer containing silane groups is storage-stable, liquid at room temperature and easily handled, and permits curable compositions having excellent processability, rapid curing, high strength coupled with good extensibility, and good thermal stability. It is particularly suitable as a constituent of moisture-curable sealants, adhesives or coatings, additionally including a further, in particular linear, polymer containing silane groups.

### TECHNICAL FIELD

The invention relates to polymers containing silane groups and to the use thereof in curable compositions, especially moisture-curing adhesives, sealants or coatings.

### STATE OF THE ART

Polymers containing silane groups, also called silane-functional or silane-terminated polymers, are known as a constituent of moisture-curing adhesives, sealants or coatings.

There are various known routes to polymers containing silane groups. There are firstly what are called the MS polymers that are obtained by hydrosilylation of allyl ether-terminated polyether polyols; there are also what are called the SPUR polymers that are obtained from the reaction of isocyanatosilanes with polyether polyols; and there are finally polymers containing silane groups from the reaction of amino- or hydroxysilanes with polymers containing isocyanate groups from the reaction of polyether polyols and monomeric diisocyanates.

The latter are of the greatest interest in respect of mechanical properties, in particular good strength coupled with high extensibility. Polymers containing isocyanate groups that serve as starting materials for preparation thereof are prepared by reacting monomeric diisocyanates and polyether diols in an NCO/OH ratio of about 2/1, described, for example, in U.S. Pat. Nos. 6,545,087 or 9,790,315. They contain considerable amounts of monomeric diisocyanate and chain-extended polymers in which two or more polyether diols are appended via the monomeric diisocyanate. On account of these secondary constituents, the polymers containing silane groups that are obtained therefrom have high viscosity, as a result of which they are typically diluted with a little plasticizer in order to be easier to handle at room temperature. However, compositions comprising these polymers containing silane groups exhibit poor thermal stability after curing, especially at temperatures of 80 or 90° C. or higher.

Also known are polymers containing silane groups from the reaction of polyether triols with isocyanatosilanes, for example from US 2014/187705. These polymers are significantly less viscous, but have considerably lower strength and extensibility and are likewise unsatisfactory in their thermal stability after curing.

### SUMMARY OF THE INVENTION

It is therefore an object of the present invention to provide polymers containing silane groups that alongside high strength and good extensibility permit improved thermal stability after curing.

This object is achieved by a branched polymer containing silane groups as claimed in claim 1. It is obtained from the reaction with an amino-, mercapto- or hydroxysilane of a polymer containing isocyanate groups that is prepared from a polyether triol, in a stoichiometric ratio of at least 1/1 in respect of the isocyanate groups. The inventive polymer containing silane groups is free of isocyanate groups. It is branched and has an average of more than two silane groups per molecule. It is preferably used in a curable composition that additionally comprises at least one further, in particular linear, polymer containing silane groups.

Surprisingly, it significantly improves the thermal stability of the composition without causing any appreciable loss of strength and extensibility in the composition.

In a preferred embodiment, the monomeric diisocyanate is IPDI. Thus present are polymers having particularly low viscosity that can be easily handled at room temperature even without a large excess of NCO and subsequent removal of the monomer. They enable particularly good processability and improved thermal stability after curing.

In a further preferred embodiment, the monomeric diisocyanate is 4,4′-MDI and the polymer containing isocyanate groups is produced with an NCO/OH ratio of at least 3/1 and subsequent removal of unreacted monomeric diisocyanate. Although such a branched polymer containing silane groups is significantly more viscous, it is still easy to handle at room temperature and, when used in a curable composition with a linear polymer containing silane groups, permits not only improved thermal stability but also significantly increased strength without losses of extensibility.

The inventive polymer containing silane groups is storage-stable, liquid at room temperature and easy to handle, and permits curable compositions having excellent processability, rapid curing, high strength coupled with good extensibility, and surprisingly good thermal stability. It is particularly suitable as a constituent of moisture-curable sealants, adhesives or coatings, which in particular additionally comprise a further, in particular linear, polymer containing silane groups. Further aspects of the invention are the subject of further independent claims.

Particularly preferred embodiments of the invention are the subject of the dependent claims.

Ways of Executing the Invention

The invention provides a branched polymer containing silane groups from the reaction of
(i) a polymer containing isocyanate groups and having an NCO content within a range from 0.7% to 4% by weight, obtained from the reaction of at least one monomeric diisocyanate with at least one polyether triol having an average OH functionality within a range from 2.2 to 3 and an OH value within a range from 15 to 58 mg KOH/g in a molar NCO/OH ratio of at least 1.5/1,
(ii) with at least one amino-, mercapto- or hydroxysilane, in a stoichiometric ratio of at least 1 mol of amino-, mercapto- or hydroxysilane per molar equivalent of isocyanate groups.

“Monomeric diisocyanate” refers to an organic compound having two isocyanate groups separated by a divalent hydrocarbyl radical having 4 to 15 carbon atoms.

“NCO content” refers to the content of isocyanate groups in % by weight.

“Organosilane” or “silane” for short refers to an organic compound having at least one silane group.

An “alkoxysilane group” or “silane group” for short refers to a silyl group bonded to an organic radical and having one to three, especially two or three, hydrolyzable alkoxy radicals on the silicon atom.

“Aminosilane”, “mercaptosilane” or “hydroxysilane” refer respectively to organosilanes having an amino, mercapto or hydroxyl group on the organic radical in addition to the silane group.

“Molecular weight” refers to the molar mass (in grams per mole) of a molecule or a molecule residue. “Average molecular weight” refers to the number-average molecular weight (Mₙ) of a polydisperse mixture of oligomeric or polymeric molecules or molecule residues. It is determined by gel-permeation chromatography (GPC) against polystyrene as standard.

The term “molar ratio” in connection with reactive groups relates to the ratio of the number of molar equivalents of the corresponding reactive groups.

A dashed line in the formulas in each case represents the bond between a substituent and the corresponding molecular radical.

“Plasticizer” refers to nonvolatile substances that are not chemically incorporated into the polymer in the course of curing and that exert a plasticizing effect on the cured polymer.

A substance or composition is referred to as “storage-stable” or “storable” when it can be stored at room temperature in a suitable container for a prolonged period, typically for at least 3 months up to 6 months or longer, without this storage resulting in any change in its application properties or use properties to an extent relevant to its use.

“Room temperature” refers to a temperature of 23° C.

All industry standards and norms mentioned in this document relate to the versions valid at the date of first filing.

Percentages by weight (% by weight), abbreviated to wt %, refer to proportions by mass of a constituent of a composition or a molecule based on the overall composition or the overall molecule, unless otherwise stated. The terms “mass” and “weight” are used synonymously in the present document.

The inventive polymer containing silane groups is free of isocyanate groups.

It is liquid, in particular at room temperature.

The branched polymer containing silane groups preferably has only a low content of plasticizers. It especially contains less than 15% by weight, preferably less than 12% by weight, of plasticizers. Most preferably it is entirely free of plasticizers. Such a polymer, when used in a curable composition, permits high freedom as to whether, how much, and which plasticizer the composition is to contain.

The branched polymer containing silane groups preferably has silane groups of formula (I)

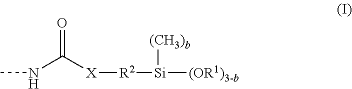

where
b is 0, 1 or 2, especially 0 or 1,
R¹ is an alkyl radical optionally containing ether groups and having 1 to 10 carbon atoms,
R² is a divalent hydrocarbyl radical having 1 to 12 carbon atoms that optionally has cyclic and/or aromatic moieties and optionally one or more heteroatoms, especially an amido, carbamate or morpholino group, and
X is O, S or NR³ where R³ is H or a monovalent hydrocarbyl radical having 1 to 20 carbon atoms that optionally has heteroatoms in the form of alkoxysilyl, ether or carboxylic ester groups.

Preferably, R¹ is methyl or ethyl or isopropyl.

More preferably, R¹ is methyl. Polymers of this kind containing silane groups are particularly reactive.

Also more preferably, R¹ is ethyl. Such polymers containing silane groups are particularly storage-stable and toxicologically advantageous.

Preferably, X is O or NR³.

Preferably, R³ is H, ethyl, butyl, phenyl or an aliphatic hydrocarbyl radical having 6 to 20 carbon atoms that optionally has ether or carboxylic acid groups.

Most preferably, X is NR³ and R³ is

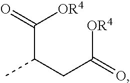

where R⁴ is methyl or ethyl, especially ethyl.

When X═NR³, R² is preferably 1,3-propylene, 1,3-butylene or 1,4-butylene, where butylene may be substituted by one or two methyl groups, more preferably 1,3-propylene.

When X═O, R² is preferably a divalent hydrocarbyl radical having 6 to 12 carbon atoms that has an amido, carbamate or morpholino group, especially a radical of formula

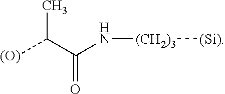

The preferred silane groups of formula (I) permit high strengths coupled with high extensibility.

Aside from the silane groups of formula (I), the branched polymer containing silane groups preferably has no further silane groups that do not correspond to the formula (I). In particular, it has no isocyanate groups attached directly to the polyether triol via isocyanatosilane. Such silane groups attached via isocyanatosilane decrease strength and thermal stability after curing.

Preferably, the branched polymer containing silane groups has an average of 2.1 to 4, more preferably 2.2 to 3.5, silane groups per molecule.

Preferably, the branched polymer containing silane groups has an average molecular weight Mₙ within a range from 5000 to 30 000 g/mol, preferably 6000 to 20 000 g/mol, especially 7000 to 15 000 g/mol.

The polymer containing isocyanate groups from which the branched polymer containing silane groups is derived preferably has an NCO content within a range from 0.8% to 3.5% by weight, more preferably 1% to 3% by weight, especially 1.2% to 2.5% by weight.

Suitable monomeric diisocyanates are commercial aromatic or aliphatic diisocyanates, especially diphenylmethane 4,4′-diisocyanate, optionally containing proportions of diphenylmethane 2,4′- and/or 2,2′-diisocyanate (MDI), tolylene 2,4-diisocyanate or mixtures thereof with tolylene 2,6-diisocyanate (TDI), phenylene 1,4-diisocyanate (PDI), naphthalene 1,5-diisocyanate (NDI), hexane 1,6-diisocyanate (HDI), 2,2(4),4-trimethylhexamethylene 1,6-diisocyanate (TMDI), cyclohexane 1,3- or 1,4-diisocyanate, 1-isocyanato-3,3,5-trimethyl-5-isocyanatomethylcyclohexane (isophorone diisocyanate or IPDI), perhydro-diphenylmethane 2,4′- or 4,4′-diisocyanate (HMDI), 1,3- or 1,4-bis(isocyanatomethyl)cyclohexane, m- or p-xylylene diisocyanate (XDI), m-tetramethylxylylene diisocyanate (TMXDI), or mixtures thereof.

More preferably, the monomeric diisocyanate is selected from the group consisting of MDI, TDI, HDI and IPDI.

Particular preference among these is given to IPDI. The polymers containing silane groups thus obtained have particularly low viscosity and permit compositions having particularly good processability, high extensibility, and particularly good light stability.

Particular preference among these is also given to MDI, especially diphenylmethane 4,4′-diisocyanate (4,4′-MDI). The polymers containing silane groups obtained therewith permit compositions having particularly high strength.

Suitable polyether triols are commercial triols that are preferably liquid at room temperature.

The polyether triol has an average OH functionality within a range from 2.2 to 3. As a consequence of their production, commercial polyether triols have a certain content of monools, as a result of which their average OH functionality is typically somewhat below 3. They thus typically contain trifunctional and monofunctional components.

Repeat units present in the polyether triol are preferably 1,2-ethyleneoxy, 1,2-propyleneoxy, 1,3-propyleneoxy, 1,2-butyleneoxy or 1,4-butyleneoxy groups, especially 1,2-ethyleneoxy and/or 1,2-propyleneoxy groups.

More preferably, repeat units present in the polyether triol are mainly or exclusively 1,2-propyleneoxy groups. More particularly, the polyether triol, based on all repeat units, contains 80% to 100% by weight of 1,2-propyleneoxy groups and 0% to 20% by weight of 1,2-ethyleneoxy groups.

The polyether triol has preferably been started using trimethylolpropane or glycerol.

The polyether triol has an OH value within a range from 15 to 58 mg KOH/g. It preferably has an OH value within a range from 20 to 40 mg KOH/g. Such a polyether triol has in particular an average molecular weight Mₙ within a range from 3000 to 10 000 g/mol, preferably 4000 to 9000 g/mol.

The reaction between the monomeric diisocyanate and the polyether triol is preferably carried out with exclusion of moisture at a temperature within a range from 20 to 160° C., especially 40 to 140° C., optionally in the presence of suitable catalysts.

In the reaction, the OH groups of the polyether polyol react with the isocyanate groups of the monomeric diisocyanate. This results also in what are called chain extension reactions, in that there is reaction of OH groups and/or isocyanate groups of products of the reaction between polyol and monomeric diisocyanate. The higher the molar NCO/OH ratio chosen, the lower the level of chain extension reactions that takes place, and the lower the polydispersity of the polymer obtained. A measure of the chain extension reaction is the average molecular weight of the polymer, or the width and distribution of the peaks in the GPC analysis. A further measure is the effective NCO content of the polymer freed of monomers relative to the theoretical NCO content calculated from the reaction of every OH group with a monomeric diisocyanate.

In a preferred embodiment of the invention, the molar NCO/OH ratio in the reaction is preferably within a range from 1.6/1 to 2.5/1, more preferably within a range from 1.8/1 to 2.3/1, especially within a range from 1.9/1 to 2.2/1. Such a polymer containing isocyanate groups is particularly easy to prepare. It contains a certain proportion of unreacted monomeric diisocyanates, typically within a range of about 0.5% to 3.5% by weight, and a certain proportion of chain-extended components. As a result, its viscosity is somewhat higher.

For the reaction in a molar NCO/OH ratio within a range from 1.5/1 to 2.5/1, the monomeric diisocyanate is preferably TDI or IPDI, especially IPDI. A polymer produced in this way has particularly low viscosity and is easy to handle at room temperature.

In a further preferred embodiment of the invention, the molar NCO/OH ratio in the reaction is at least 3/1, preferably within a range from 3/1 to 20/1, more preferably within a range from 4/1 to 15/1, especially within a range of 5/1 to 13/1, and after the reaction a major part of the unreacted monomeric diisocyanate is removed by means of a suitable method of separation.

Such a polymer containing isocyanate groups has a particularly low content of monomeric diisocyanates and a particularly low content of chain-extended components.

It preferably has a monomeric diisocyanate content of not more than 0.3% by weight, preferably not more than 0.25% by weight.

Such a polymer containing isocyanate groups has particularly low viscosity. In particular, this production process also allows the use of monomeric diisocyanates that are otherwise less suitable for the reaction with polyether triols, such as MDI in particular, since it is possible for undesirably high viscosity up to the point of gelation to occur during preparation.

Preference as the method of separation is given to a distillative method, especially thin-film distillation or short-path distillation, preferably with application of reduced pressure.

Particular preference is given to a multistage process in which the monomeric diisocyanate is removed in a short-path evaporator with a jacket temperature within a range from 120 to 200° C. and a pressure of 0.001 to 0.5 mbar.

In the case of 4,4′-MDI, which is preferred, distillative removal is a particular challenge. For example, it is necessary to ensure that the condensate does not solidify and block the system. Preference is given to operating at a jacket temperature within a range from 160 to 200° C., at 0.001 to 0.5 mbar, and condensing the monomeric diisocyanate removed at a temperature within a range from 40 to 60° C.

Preference is given to reacting the monomeric diisocyanate with the polyether polyol and subsequently removing the major part of the monomeric diisocyanate remaining in the reaction mixture without the use of solvents or entraining agents. Preferably, the monomeric diisocyanate removed after the reaction is subsequently reused, i.e. used again for the preparation of polymer containing isocyanate groups.

For reaction in a molar NCO/OH ratio of at least 3/1 and subsequent removal of a major part of the monomeric diisocyanates by means of a suitable method of separation, the monomeric diisocyanate is preferably IPDI or MDI.

Very particular preference for this purpose is given to MDI, especially 4,4′-MDI. A polymer containing silane groups from the reaction of a polyether triol and 4,4′-MDI permits particularly high strength coupled with high thermal stability. However, the preparation thereof is also a particular challenge. In the conventional route, such polymers containing isocyanate groups typically become so highly viscous that they are difficult to handle without diluting with large amounts of plasticizers or solvents. Such polymers often already gel during preparation.

The polymer containing isocyanate groups is highly storage-stable with exclusion of moisture.

It is reacted with at least one amino-, mercapto- or hydroxysilane in a stoichiometric ratio of at least 1 mol of amino-, mercapto- or hydroxysilane per molar equivalent of isocyanate groups, which affords the inventive branched polymer containing silane groups.

The amino-, mercapto- or hydroxysilane for the reaction with the polymer containing isocyanate groups is preferably a silane of formula (II)

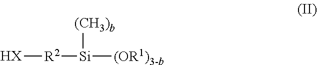

where R¹, R², X, and b are as defined previously.

Preferred silanes of formula (II) are selected from the group consisting of 3-aminopropyltrimethoxysilane, 3-aminopropyldimethoxymethylsilane, 4-aminobutyltrimethoxysilane, 4-amino-3-methylbutyltrimethoxysilane, 4-amino-3,3-dimethylbutyltrimethoxysilane, N-ethyl-3-amino-(2-methylpropyl)trimethoxysilane, N-butyl-3-aminopropyltrimethoxysilane, N-phenyl-3-aminopropyltrimethoxysilane, diethyl N-(3-trimethoxysilylpropyl)aminosuccinate, diethyl N-(3-dimethoxymethylsilylpropyl)aminosuccinate, 3-mercaptopropyltrimethoxysilane, 3-mercaptopropyldimethoxymethylsilane, N-(3-trimethoxysilylpropyl)-2-hydroxypropanamide, N-(3-trimethoxysilylpropyl)-4-hydroxypentanamide, N-(3-trimethoxysilylpropyl)-4-hydroxyoctanamide, N-(3-trimethoxysilylpropyl)-5-hydroxydecanamide, N-(3-trimethoxysilylpropyl)-2-hydroxypropyl carbamate, 2-morpholino-4(5)-(2-trimethoxysilylethyl)cyclohexan-1-ol, 2-morpholino-4(5)-(2-trimethoxysilylethyl)cyclohexan-1-ol, 1-morpholino-3-(3-(triethoxysilyl)propoxy)propan-2-ol, and the corresponding analogs with ethoxy groups in place of the methoxy groups on the silicon.

A particularly preferred silane of formula (II) is diethyl N-(3-trimethoxysilylpropyl)aminosuccinate, diethyl N-(3-triethoxysilylpropyl)aminosuccinate, diethyl N-(3-dimethoxymethylsilylpropyl)aminosuccinate, diethyl N-(3-diethoxymethylsilylpropyl)aminosuccinate, N-(3-trimethoxysilylpropyl) hydroxypropanamide, N-(3-triethoxysilylpropyl)-2-hydroxypropanamide, N-(3-dimethoxymethylsilylpropyl)-2-hydroxypropanamide or N-(3-diethoxymethylsilylpropyl)-2-hydroxypropanamide.

A very particularly preferred silane of formula (II) is diethyl N-(3-trimethoxysilylpropyl)aminosuccinate, diethyl N-(3-triethoxysilylpropyl)aminosuccinate, diethyl N-(3-dimethoxymethylsilylpropyl)aminosuccinate or diethyl N-(3-diethoxymethylsilylpropyl)aminosuccinate.

The amino-, mercapto- or hydroxysilane is reacted with the polymer containing isocyanate groups in a stoichiometric ratio of at least 1 mol of amino-, mercapto-or hydroxysilane per molar equivalent of isocyanate groups.

Preference is given to a stoichiometry within a range from 1 to 1.3, preferably 1 to 1.2, especially 1 to 1.1, mol of amino-, mercapto- or hydroxysilane per molar equivalent of isocyanate groups.

The reaction is carried out at a temperature within a range from 20 to 160° C., especially 60 to 120° C. A catalyst is optionally used here, especially a tertiary amine or a metal compound, especially a bismuth(III), zinc(II), zirconium(IV) or tin(II) compound or an organotin(IV) compound.

A particularly preferred branched polymer containing silane groups is derived from IPDI as monomeric diisocyanate. It thus especially has silane groups of formula (Ia) or (Ib)

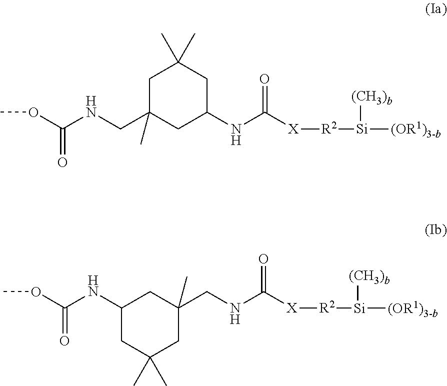

where R¹, R², X, and b are as defined previously. Such a polymer permits high extensibility and particularly high light stability coupled with good thermal stability. It is preferably prepared with a molar NCO/OH ratio within a range from 1.5/1 to 2.5/1 without subsequent removal of monomeric diisocyanate, or with an NCO/OH ratio of at least 3/1 and subsequent removal of a major part of the monomeric diisocyanate by means of a suitable method of separation. More preferably, it is prepared with a molar NCO/OH ratio within a range from 1.5/1 to 2.5/1 without subsequent removal of monomeric diisocyanate.

Another particularly preferred branched polymer containing silane groups is derived from 4,4′-MDI as monomeric diisocyanate. It thus especially has silane groups of formula (Ic),

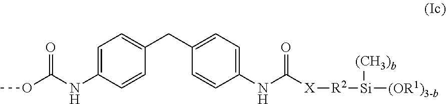

where R¹, R², X, and b are as defined previously. It permits compositions having particularly high strength and good thermal stability.

It is preferably prepared with a molar NCO/OH ratio of at least 3/1 and subsequent removal of a major part of the monomeric diisocyanate by means of a suitable method of separation.

The branched polymer containing silane groups is storage-stable with exclusion of moisture. On contact with moisture, the silane groups undergo hydrolysis. This results in the formation of silanol groups (Si—OH groups) and, through subsequent condensation reactions, siloxane groups (Si—O—Si groups). As a result of these reactions, the polymer cures to give a crosslinked plastic. The moisture for the curing may either come from the air (air humidity) or the polymer may be contacted with a water-containing component, for example by painting, spraying or mixing. During curing, silanol groups can condense with, for example, hydroxyl groups of a substrate to which the polymer has been applied, as a result of which an additional improvement in adhesion to the substrate is possible on crosslinking.

The invention further provides a process for preparing the branched polymer containing silane groups, characterized in that
(a) at least one monomeric diisocyanate is reacted with at least one polyether triol having an average OH functionality within a range from 2.2 to 3 and an OH value within a range from 15 to 58 mg KOH/g in a molar NCO/OH ratio of at least 1.5/1,
(b) a major part of the unreacted monomeric diisocyanate is then optionally removed by means of a suitable method of separation, particularly when a molar NCO/OH ratio of at least 3/1 had been present,
(c) and the resulting polymer containing isocyanate groups is then reacted with at least one amino-, mercapto- or hydroxysilane in a stoichiometric ratio of at least 1 mol of amino-, mercapto- or hydroxysilane per molar equivalent of isocyanate groups.

In a preferred aspect of the invention, at least one polyether diol is present in step a) in addition to the polyether triol. This results in the formation in situ of a mixture of an inventive branched polymer containing silane groups and a noninventive linear polymer containing silane groups.

The weight ratio between the polyether triol and the polyether diol is here preferably within a range from 10/90 to 70/30, especially 15/85 to 60/40.

A polyether diol suitable for this purpose has in particular an OH value within a range from 5 to 40 mg KOH/g, preferably 6 to 20 mg KOH/g, especially 7 to 15 mg KOH/g.

It contains, based on its repeat units, preferably 80% to 100% by weight of 1,2-propyleneoxy groups and 0% to 20% by weight of 1,2-ethyleneoxy groups. Such a linear polymer containing silane groups permits compositions having particularly high extensibility and elasticity.

The present invention further provides the reaction product from the process of the invention.

The invention further provides a curable composition comprising the inventive branched polymer containing silane groups and at least one further constituent selected from the group consisting of catalysts, crosslinkers, adhesion promoters, desiccants, plasticizers, and fillers.

Suitable catalysts are metal catalysts and/or nitrogen compounds that accelerate the crosslinking of polymers containing silane groups.

Suitable metal catalysts are especially compounds of titanium, zirconium, aluminum, or tin, especially organotin compounds, organotitanates, organozirconates or organoaluminates, these compounds especially having alkoxy groups, aminoalkoxy groups, sulfonate groups, carboxyl groups, 1,3-diketonate groups, 1,3-ketoesterate groups, dialkyl phosphate groups or dialkyl pyrophosphate groups.

Particularly suitable organotin compounds are dialkyltin oxides, dialkyltin dichlorides, dialkyltin dicarboxylates, and dialkyltin diketonates, especially dibutyltin oxide, dibutyltin dichloride, dibutyltin diacetate, dibutyltin dilaurate, dibutyltin diacetylacetonate, dioctyltin oxide, dioctyltin dichloride, dioctyltin diacetate, dioctyltin dilaurate or dioctyltin diacetylacetonate, or alkyltin thioesters. Particularly suitable organotitanates are bis(ethylacetoacetato)diisobutoxytitanium(IV), bis(ethylacetoacetato)diisopropoxytitanium(IV), bis(acetylacetonato)diisopropoxytitanium(IV), bis(acetylacetonato)diisobutoxytitanium(IV), tris(oxyethyl)amineisopropoxytitanium(IV), bis[tris(oxyethyl)amine]diisopropoxytitanium(IV), bis(2-ethylhexane-1,3-dioxy)titanium(IV), tris[2-((2-aminoethyl)amino)ethoxy]ethoxytitanium(IV), bis(neopentyl(diallyl)oxy)-diethoxytitanium(IV), titanium(IV) tetrabutoxide, tetra(2-ethylhexyloxy) titanate, tetra(isopropoxy) titanate or polybutyl titanate. Especially suitable are the commercially available products Tyzor® AA, GBA, GBO, AA-75, AA-65, AA-105, DC, BEAT, BTP, TE, TnBT, KTM, TOT, TPT or IBAY (all from Dorf Ketal); Tytan PBT, TET, X85, TAA, ET, S2, S4 or S6 (all from Borica Company Ltd.) and Ken-React® KR® TTS, 7, 9QS, 12, 26S, 33DS, 38S, 39DS, 44, 134S, 138S, 133DS, 158FS or LICA® 44 (all from Kenrich Petrochemicals). Particularly suitable organozirconates are the commercially available products Ken-React® NZ® 38J, KZ® TPP, KZ® TPP, NZ® 01, 09, 12, 38, 44 or 97 (all from Kenrich Petrochemicals) or Snapcure® 3020, 3030, 1020 (all from Johnson Matthey & Brandenberger).

A particularly suitable organoaluminate is the commercially available product K-Kat 5218 (from King Industries).

Nitrogen compounds suitable as catalyst are especially amines such as, in particular, N-ethyldiisopropylamine, N,N,N′,N′-tetramethylalkylenediamines, polyoxyalkyleneamines, 1,4-diazabicyclo[2.2.2]octane; aminosilanes such as, in particular, 3-aminopropyltrimethoxysilane, 3-aminopropyldimethoxylmethylsilane, N-(2-aminoethyl)-3-aminopropyltrimethoxysilane, N-(2-aminoethyl)-3-aminopropylmethyldimethoxysilane, N-(2-aminoethyl)-N′-[3-(trimethoxysilyl)propyl]ethylenediamine or analogs thereof with ethoxy groups in place of methoxy groups on the silicon; cyclic amidines such as, in particular, 1,8-diazabicyclo[5.4.0]undec-7-ene (DBU), 1,5-diazabicyclo[4.3.0]non-5-ene (DBN), 6-dibutylamino-1,8-diazabicyclo[5.4.0]undec-7-ene; guanidines such as, in particular, tetramethylguanidine, 2-guanidinobenzimidazole, acetylacetoneguanidine, 1,3-di-o-tolylguanidine, 2-tert-butyl-1,1,3,3-tetramethylguanidine, or reaction products of carbodiimides and amines, such as, in particular, polyetheramines or aminosilanes; or imidazoles such as, in particular, N-(3-trimethoxysilylpropyl)-4,5-dihydroimidazole or N-(3-triethoxysilylpropyl)-4,5-dihydroimidazole. Also suitable are combinations of different catalysts, especially combinations of at least one metal catalyst and at least one nitrogen compound.

Preferred catalysts are organotin compounds, organotitanates, amines, especially aminosilanes, amidines, guanidines or imidazoles.

Suitable adhesion promoters and/or crosslinkers are especially aminosilanes, mercaptosilanes, epoxysilanes, (meth)acrylosilanes, anhydridosilanes, carbamatosilanes, alkylsilanes or iminosilanes, or oligomeric forms of these silanes, or adducts of primary aminosilanes with epoxysilanes or (meth)acrylosilanes or anhydridosilanes. Particularly suitable are 3-glycidoxypropyltrimethoxysilane, 3-aminopropyltrimethoxysilane, N-(2-aminoethyl)-3-aminopropyl-trimethoxysilane, N-(2-aminoethyl)-N′-[3-(trimethoxysilyl)propyl]ethylenediamine, 3-mercaptopropyltrimethoxysilane, 3-ureidopropyltrimethoxysilane or the corresponding silanes with ethoxysilane groups in place of the methoxysilane groups on the silicon, or oligomeric forms of these silanes.

Particularly suitable desiccants are tetraethoxysilane, vinyltrimethoxysilane, vinyltriethoxysilane, organosilanes having a functional group in the α-position to the silane group, especially N-(methyldimethoxysilylmethyl)-O-methylcarbamate or (methacryloyloxymethyl)silanes, methoxymethylsilanes, orthoformic esters, and also calcium oxide or molecular sieves. Preference is given to vinyltrimethoxysilane or vinyltriethoxysilane. Preference is here given to vinyltrimethoxysilane when the branched polymer containing silane groups has methoxysilane groups, whereas vinyltriethoxysilane is preferred when the branched polymer containing silane groups has ethoxysilane groups.

Suitable plasticizers are especially carboxylic esters, such as phthalates, especially diisononyl phthalate (DINP), diisodecyl phthalate (DIDP) or di(2-propylheptyl)phthalate (DPHP), hydrogenated phthalates or cyclohexane-1,2-dicarboxylates, especially hydrogenated diisononyl phthalate or diisononyl cyclohexane-1,2-dicarboxylate (DINCH), terephthalates, especially bis(2-ethylhexyl) terephthalate (DOTP) or diisononyl terephthalate (DINT), hydrogenated terephthalates or cyclohexane-1,4-dicarboxylates, especially hydrogenated bis(2-ethylhexyl) terephthalate or bis(2-ethylhexyl) cyclohexane-1,4-dicarboxylate, or hydrogenated diisononyl terephthalate or diisononyl cyclohexane-1,4-dicarboxylate, isophthalates, trimellitates, adipates, especially dioctyl adipate, azelates, sebacates, benzoates, polyols, especially polyether polyols or polyester polyols, glycol ethers, glycol esters, polyether mono- or polyols having blocked hydroxyl groups, especially in the form of acetate groups, organic phosphoric or sulfonic esters, polybutenes or plasticizers derived from natural fats or oils, especially fatty acid methyl or ethyl esters, also called “biodiesel”, or epoxidized soybean or linseed oil.

Suitable fillers are especially ground or precipitated calcium carbonates, optionally coated with fatty acids, especially stearates, barytes, quartz flours, quartz sands, dolomites, wollastonites, calcined kaolins, sheet silicates, such as mica or talc, zeolites, aluminum hydroxides, magnesium hydroxides, silicas, including finely divided silicas from pyrolysis processes, cements, gypsums, fly ashes, industrially produced carbon blacks, graphite, metal powders, for example of aluminum, copper, iron, silver or steel, PVC powders or hollow beads. Preference is given to precipitated, fatty acid-coated calcium carbonate and/or carbon black.

Further suitable constituents are especially the following auxiliaries and additives:
oligomers or polymers containing silane groups;
solvents;
fibers, in particular glass fibers, carbon fibers, metal fibers, ceramic fibers, polymer fibers, such as polyamide fibers or polyethylene fibers, or natural fibers, such as wool, cellulose, hemp or sisal;
nanofillers such as graphene or carbon nanotubes;
dyes;
inorganic or organic pigments, in particular titanium dioxide, chromium oxides or iron oxides;
rheology modifiers, in particular thickeners, in particular sheet silicates, such as bentonites, derivatives of castor oil, hydrogenated castor oil, polyamides, polyamide waxes, polyurethanes, urea compounds, fumed silicas, cellulose ethers or hydrophobically modified polyoxyethylenes;
stabilizers against oxidation, heat, light or UV radiation;
natural resins, fats or oils, such as rosin, shellac, linseed oil, castor oil or soybean oil;
nonreactive polymers, in particular homo- or copolymers of unsaturated monomers, in particular from the group comprising ethylene, propylene, butylene, isobutylene, isoprene, vinyl acetate or alkyl (meth)acrylates, in particular polyethylenes (PE), polypropylenes (PP), polyisobutylenes, ethylene/vinyl acetate copolymers (EVA) or atactic poly-α-olefins (APAO); flame-retardant substances, especially the already mentioned fillers aluminum hydroxide or magnesium hydroxide, or organic phosphoric esters;
additives, in particular wetting agents, leveling agents, defoamers, deaerators, stabilizers against oxidation, heat, light or UV radiation, or biocides.

It may be advisable for certain constituents to undergo chemical or physical drying before being mixed into the composition.

The curable composition contains preferably 5% to 80% by weight, more preferably 10% to 70% by weight, especially 20% to 60% by weight, of polymers containing silane groups.

In a preferred embodiment of the invention, the curable composition comprises at least one further, noninventive polymer containing silane groups.

In particular, this further polymer containing silane groups is linear. It preferably has an average of 1.7 to 2, more preferably 1.8 to 2, especially 1.9 to 2, silane groups per molecule.

The weight ratio here between the inventive branched polymer containing silane groups and the further polymer containing silane groups is preferably within a range from 10/90 to 70/30, especially 15/85 to 60/40.

The further polymer containing silane groups is preferably selected from the group consisting of
polymers containing silane groups that are derived from polymers containing isocyanate groups from the reaction of monomeric diisocyanates and polyether diols in a molar NCO/OH ratio of at least 1.5/1;
polyethers containing silane groups that are obtained from the reaction of polyethers containing allyl groups with hydrosilanes, optionally with chain extension, especially with diisocyanates;
polyethers containing silane groups that are obtained from the copolymerization of alkylene oxides and epoxysilanes, optionally with chain extension, especially with diisocyanates;
polyethers containing silane groups that are obtained from the reaction of polyether polyols, especially diols, with isocyanatosilanes, optionally with chain extension using diisocyanates.

The inventive branched polymer containing silane groups here improves the thermal stability and possibly the strength and/or extensibility of the composition.

Preference as further polymers containing silane groups is given to those derived from polymers containing isocyanate groups from the reaction of monomeric diisocyanates and polyether diols in a molar NCO/OH ratio of at least 1.5/1.

A polyether diol suitable for this purpose has in particular an OH value within a range from 5 to 40 mg KOH/g, preferably 6 to 20 mg KOH/g, especially 7 to 15 mg KOH/g. In particular, it has an average molecular weight Mₙ within a range from 3500 to 20 000 g/mol, preferably 5000 to 18 000 g/mol, especially 7500 to 16 000 g/mol. Such a polymer permits compositions having particularly high extensibility and elasticity.

Such a mixture of inventive branched polymer and noninventive polymer can in particular also be prepared such that the monomeric diisocyanate is mixed with a mixture of at least one polyether triol as described and at least one polyether diol in a molar NCO/OH ratio of at least 1.5/1 to the polymer containing isocyanate groups, and this is then reacted with at least one amino, mercapto or hydroxysilane as described.

The curable composition is especially produced with exclusion of moisture and stored at ambient temperature in moisture-tight containers. A suitable moisture-tight container especially consists of an optionally coated metal and/or plastic, and is especially a drum, a transport box, a hobbock, a bucket, a canister, a can, a bag, a tubular bag, a cartridge or a tube.

The curable composition may be in the form of a one-component composition or in the form of a two-component composition.

A “one-component” composition refers to one in which all constituents of the composition are stored mixed together in the same container and which is curable with moisture.

A “two-component” composition refers to one in which the constituents of the composition are present in two different components that are stored in separate containers. The two components are not mixed with one another until shortly before or during application of the composition, whereupon the mixed composition cures, with the curing proceeding or being completed only through the action of moisture.

The curable composition is preferably a one-component composition. Given suitable packaging and storage, it is storage-stable, typically for several months up to one year or longer.

On application of the curable composition, the silane groups present come into contact with moisture, which commences the process of curing. Curing proceeds with varying rapidity depending on the temperature, nature of contact, amount of moisture, and presence of any catalysts. In the case of curing by means of air humidity, a skin first forms on the surface of the composition. What is called the skin time is a measure of the curing rate.

This results in formation of the cured composition.

In the case of a one-component composition, it is applied as is and then begins to cure under the influence of moisture or water. For acceleration of curing, an accelerator component that contains or releases water and/or a catalyst and/or a curing agent can be mixed into the composition on application, or the composition, after application thereof, can be contacted with such an accelerator component. The curable composition is preferably applied at ambient temperature, especially within a range from about −10 to 50° C., preferably within a range from −5 to 45° C., especially 0 to 40° C.

Curing preferably likewise takes place at ambient temperature.

In the cured state, the composition has markedly elastic properties, in particular high strength and high extensibility, good thermal stability, and good adhesion properties on various substrates. As a result, it is suitable for a multitude of uses, especially as sealant, adhesive, covering, coating or paint for construction or industrial applications, for example as joint sealant, parquet adhesive, assembly adhesive, glazing adhesive, or bodywork sealant, seam sealant or cavity sealant, as floor covering, floor coating, balcony coating, roof coating or parking garage coating.

Preference is given to using the curable composition as elastic adhesive or elastic sealant or elastic coating.

The curable composition can be formulated such that it has a pasty consistency with structurally viscous properties. A composition of this kind is applied by means of a suitable device, for example from commercial cartridges or drums or hobbocks, for example in the form of a bead, which may have an essentially round or triangular cross-sectional area.

The curable composition can also be formulated such that it is fluid and “self-leveling” or only slightly thixotropic and can be poured out for application. As coating, it can for example then be distributed over an area to give the desired layer thickness, for example by means of a roller, a slide bar, a toothed applicator or a trowel. In an operation, a layer thickness within a range from 0.5 to 3 mm, especially 1 to 2.5 mm, is typically applied.

Suitable substrates for bonding or sealing or coating are especially
glass, glass ceramic, screenprinted ceramic, concrete, mortar, cement screed, fiber cement, especially fiber cement boards, brick, tile, plaster, especially plasterboards or anhydride screed, or natural stone, such as granite or marble;
metals or alloys, such as aluminum, copper, iron, steel, nonferrous metals, including surface-finished metals or alloys, such as zinc-plated or chromium-plated metals;
plastics, in particular rigid or flexible PVC, polycarbonate (PC), polyamide (PA), polyesters, PMMA, ABS, SAN, epoxy resins, phenolic resins, PUR, POM, TPO, PE, PP, EPM or EPDM, where the surface of the plastics has optionally undergone plasma, corona or flame treatment;
paints or varnishes, especially automotive topcoats;
repair or leveling compounds based on PCC (polymer-modified cement mortar) or ECC (epoxy resin-modified cement mortar);
asphalt or bitumen;
leather, textiles, paper, wood, wood-based materials bonded with resins such as phenolic, melamine or epoxy resins, resin-textile composites or other so-called polymer composites;
insulation foams, especially made of EPS, XPS, PUR, PIR, rock wool, glass wool or foamed glass.

If required, the substrates can be pretreated prior to application, especially by physical and/or chemical cleaning methods or the application of an activator or a primer.

It is possible to bond or seal two identical or two different substrates.

After the bonding or sealing of two substrates, a bonded or sealed article is obtained. This article may be a built structure or a part thereof, especially a built structure above or below ground, a bridge, a roof, a staircase or a façade, or it may be an industrial product or a consumer product, especially a window, a pipe, a domestic appliance or a mode of transport, such as especially an automobile, a bus, a truck, a rail vehicle, a ship, an aircraft or a helicopter, or an installable component thereof.

The invention further provides the cured composition obtained from the curable composition after contact thereof with moisture.

The inventive composition is with the exclusion of moisture storage-stable and readily processable. It cures rapidly and after curing has high strength coupled with good extensibility, good adhesion properties, and surprisingly good thermal stability.

### EXAMPLES

Working examples are presented hereinbelow, the purpose of which is to further elucidate the described invention. The invention is of course not limited to these described working examples.

“Standard climatic conditions” (“SCC”) refer to a temperature of 23±1° C. and a relative air humidity of 50±5%.

The chemicals used were unless otherwise stated from Sigma-Aldrich.

Diisodecyl phthalate was used in the form of Palatinol® 10-P (from BASF).

Viscosity was measured using a thermostated Rheotec RC30 cone-plate viscometer (cone diameter 25 mm, cone angle 1°, cone tip-plate distance 0.05 mm, shear rate 10 s⁻¹).

Monomeric diisocyanate content was determined by HPLC (detection via photodiode array; 0.04 M sodium acetate/acetonitrile as mobile phase) after prior derivatization with N-propyl-4-nitrobenzylamine.

Preparation of Polymers Containing Isocyanate Groups with Polyether Triol

Polymer T-1: (NCO/OH=2.1/1)

190.0 g of ethylene oxide-terminated polyoxypropylene triol (OH value 28 mg KOH/g, Desmophen® 5031 BT, from Covestro), 27.8 g of diisodecyl phthalate, 22.2 g of IPDI (1-isocyanato-3,3,5-trimethyl-5-isocyanatomethylcyclohexane, Vestanat® IPDI, from Evonik), and 0.12 g of dibutyltin dilaurate were reacted by a known method at 90° C. to afford a polymer having an NCO content of 1.75% by weight and a viscosity of 31 Pa·s at 20° C.

Polymer T-2:

780.0 g of ethylene oxide-terminated polyoxypropylene triol (OH value 28 mg KOH/g, Desmophen® 5031 BT, from Covestro) and 220 g of IPDI (1-isocyanato-3,3,5-trimethyl-5-isocyanatomethylcyclohexane, Vestanat® IPDI, from Evonik) were reacted in the presence of 0.01 g of dibutyltin dilaurate by a known method at 80° C. to afford a polymer having an NCO content of 6.4% by weight, a viscosity of 4.1 Pa·s at 20° C., and a monomeric IPDI content of about 12% by weight. The volatile constituents, in particular the major part of the monomeric IPDI, were then removed by distillation in a short-path evaporator (jacket temperature 160° C., pressure 0.1 to 0.005 mbar). The polymer thus obtained had an NCO content of 1.9% by weight, a viscosity of 8.2 Pa·s at 20° C., and a monomeric IPDI content of 0.02% by weight.

Polymer T-3:

725.0 g of ethylene oxide-terminated polyoxypropylene triol (OH value 28 mg KOH/g, Desmophen® 5031 BT, from Covestro) and 275 g of diphenylmethane 4,4′-diisocyanate (Desmodur® 44 MC L, from Covestro) were reacted by a known method at 80° C. to afford a polymer having an NCO content of 7.6% by weight, a viscosity of 6.5 Pa·s at 20° C., and a monomeric diphenylmethane 4,4′-diisocyanate content of approx. 20% by weight.

The volatile constituents, in particular a major part of the monomeric diphenylmethane 4,4′-diisocyanate, were then removed by distillation in a short-path evaporator (jacket temperature 180° C., pressure 0.1 to 0.005 mbar, condensation temperature 47° C.). The polymer thus obtained had an NCO content of 1.7% by weight, a viscosity of 19 Pa·s at 20° C., and a monomeric diphenylmethane 4,4′-diisocyanate content of 0.04% by weight.

Polymer T-4: (NCO/OH=2.1/1)

190.0 g of ethylene oxide-terminated polyoxypropylene triol (OH value 28 mg KOH/g, Desmophen® 5031 BT, from Covestro) and 25.0 g of diphenylmethane 4,4′-diisocyanate (Desmodur® 44 MC L, from Covestro) were reacted by a known method at 80° C. The reaction mixture underwent gelation during the reaction and was consequently unsuitable for further use.

Preparation of Polymers Containing Isocyanate Groups with Polyether Diol

Polymer L-1: (NCO/OH=2.1/1)

1000.0 g of polyoxypropylene diol (OH value 10 mg KOH/g, Acclaim® 12200N, from Covestro), 122.8 g of diisodecyl phthalate, 41.6 g of IPDI (1-isocyanato-3,3,5-trimethyl-5-isocyanatomethylcyclohexane, Vestanat® IPDI, from Evonik), and 0.12 g of dibutyltin dilaurate were reacted by a known method at 90° C. to afford a polymer having an NCO content of 0.63% by weight, a viscosity of 31 Pa·s at 20° C., and a monomeric IPDI content of about 0.5% by weight.

Silanes of Formula (II) Used:
Silane A-1 Diethyl N-(3-trimethoxysilylpropyl)aminosuccinate (351.5 g/mol), obtained from the reaction of 3-aminopropyltrimethoxysilane and diethyl maleate in a molar ratio of about 1/1

Preparation of Polymers Containing Silane Groups

Polymer ST-1: (Inventive, Branched)

To an initial charge of 240.0 g of polymer T-1, prepared as described above, was added under a nitrogen atmosphere with exclusion of moisture 36.2 g of silane A-1 and the mixture was stirred at 60° C. until isocyanate groups were no longer detectable by FT-IR spectroscopy. The resulting polymer was cooled to room temperature and stored with exclusion of moisture. It contained 10% by weight of plasticizer (diisodecyl phthalate), was clear, and on the day after preparation had a viscosity of 97 Pa·s at 20° C.

Polymer ST-2: (Inventive, Branched)

To an initial charge of 221.0 g of polymer T-2, prepared as described above, was added under a nitrogen atmosphere with exclusion of moisture 36.2 g of silane A-1 and the mixture was stirred at 60° C. until isocyanate groups were no longer detectable by FT-IR spectroscopy. The resulting polymer was cooled to room temperature and stored with exclusion of moisture. It was clear and on the day after preparation had a viscosity of 70 Pa·s at 20° C.

Polymer ST-3: (Inventive, Branched)

To an initial charge of 247.0 g of polymer T-3, prepared as described above, was added under a nitrogen atmosphere with exclusion of moisture 36.2 g of silane A-1 and the mixture was stirred at 60° C. until isocyanate groups were no longer detectable by FT-IR spectroscopy. The resulting polymer was cooled to room temperature and stored with exclusion of moisture. It was clear and on the day after preparation had a viscosity of 357 Pa·s at 20° C.

Polymer SL-1: (Noninventive, Linear)

To an initial charge of 333.3 g of polymer L-1, prepared as described above, was added under a nitrogen atmosphere with exclusion of moisture 18.1 g of silane A-1 and the mixture was stirred at 60° C. until isocyanate groups were no longer detectable by FT-IR spectroscopy. The resulting polymer was cooled to room temperature and stored with exclusion of moisture. It contained 10% by weight of plasticizer (diisodecyl phthalate), was clear, and on the day after preparation had a viscosity of 99 Pa·s at 20° C.

Polymer SPUR-1: (Comparative, Branched)

190.0 g of Desmophen® 5031 BT and 19.5 g of 3-isocyanatopropyltrimethoxysilane were reacted by a known method at 80° C. to afford a polymer containing silane groups. The resulting polymer was cooled to room temperature and stored with exclusion of moisture. It was clear and on the day after preparation had a viscosity of 5 Pa·s at 20° C.

Moisture-Curing Compositions:

Compositions Z1 to Z9:

For each composition, the ingredients specified in Tables 1 to 2 were mixed in the amounts specified (in parts by weight) with exclusion of moisture for one minute at 3000 rpm using a centrifugal mixer (SpeedMixer™ DAC 150, FlackTek Inc.) and stored with exclusion of moisture.

The compositions were tested as follows:

As a measure of storage stability, the viscosity was measured after storage with exclusion of moisture in a closed aluminum tube at room temperature after one day (1d RT) and after 7 days in an air-circulation oven at 60° C. (7d 60° C.).

As a measure of the open time, the skin time (HBZ) was determined. For this purpose, a few grams of the composition were applied to cardboard in a layer thickness of about 2 mm and the period of time under standard climatic conditions after which there were no longer any residues remaining on an LDPE pipette used to gently tap the surface of the composition was determined.

As a measure of hardness and heat stability, the Shore A hardness was determined in accordance with DIN 53505 on test specimens cured under standard climatic conditions for 7 days (7d SCC), or on test specimens stored under standard climatic conditions for 7 days and then for the specified period at the specified temperature in an air-circulation oven at 80° C., 90° C. or 100° C.

For the determination of mechanical properties, the composition was applied to a silicone-coated release paper to give a film of thickness 2 mm, which was stored under standard climatic conditions for 14 days, after which a few dumbbells having a length of 75 mm with a bar length of 30 mm and a bar width of 4 mm were punched out of the film and these were tested in accordance with DIN EN 53504 at a strain rate of 200 mm/min to determine the tensile strength (breaking force), elongation at break, and 5% modulus of elasticity (at 0.5-5% elongation).

The results are reported in Tables 1 to 2.

Comparative examples are identified by (Ref.).

TABLE 1
Composition (in parts by weight) and properties of Z1 to Z5. “n.m.”
means “not measurable”, because too soft (destroyed)

| | | Z1 | | | | Z5 |
|---|---|---|---|---|---|---|
| Composition | | (Ref.) | Z2 | Z3 | Z4 | (Ref.) |
| Polymer SL-1 | | 50.0 | 40.0 | 40.0 | 40.0 | 40.0 |
| Polymer ST-1 | | — | 10.0 | — | — | — |
| Polymer ST-2 | | — | — | 10.0 | — | — |
| Polymer ST-3 | | — | — | — | 10.0 | — |
| Polymer SPUR-1 | | — | — | — | — | 10.0 |
| AMMO¹ | | 1.0 | 1.0 | 1.0 | 1.0 | 1.0 |
| VTMO² | | 1.0 | 1.0 | 1.0 | 1.0 | 1.0 |
| DBU³ | | 0.1 | 0.1 | 0.1 | 0.1 | 0.1 |
| DBTDL⁴ | | 0.05 | 0.05 | 0.05 | 0.05 | 0.05 |
| Viscosity @ | 1 d RT | 66 | 33 | 32 | 76 | 43 |
| 20° C., | 7 d 60° C. | 52 | 35 | 32 | 78 | 38 |
| [Pa · s] | | | | | | |
| HBZ | 1 d RT | 13 | 27 | 27 | 13 | 13 |
| [min] | 7 d 60° C. | 20 | 31 | 30 | 40 | 20 |
| Shore A | 7 d SCC | 35 | 37 | 38 | 40 | 39 |
| | +7 d 80° C. | 33 | 35 | 37 | 39 | 36 |
| | +14 d 80° C. | 31 | 33 | 34 | 35 | 34 |
| | +7 d 90° C. | 29 | 30 | 31 | 31 | 26 |
| | +14 d 90° C. | n.m. | 20 | 20 | 17 | n.m. |
| | +7 d 100° C. | n.m. | 24 | 21 | 17 | n.m. |

| | | | | | |
|---|---|---|---|---|---|
| Tensile strength [MPa] | 0.59 | 0.65 | 0.63 | 1.01 | 0.68 |
| Elongation at break [%] | 72 | 77 | 63 | 125 | 72 |
| MoE 5% [MPa] | 1.12 | 1.20 | 1.32 | 1.50 | 1.30 |

¹3-Aminopropyltrimethoxysilane
²Vinyltrimethoxysilane
³1,8-Diazabicyclo[5.4.0]undec-7-ene
⁴Dibutyltin dilaurate

TABLE 2
Composition (in parts by weight) and properties of Z6 to Z9. “n.m.”
means “not measurable”, because too soft (destroyed)

| Composition | | Z6 | Z7 | Z8 | Z9 |
|---|---|---|---|---|---|
| Polymer ST-1 | | 50.0 | — | — | — |
| Polymer ST-2 | | — | 50.0 | — | — |
| Polymer ST-3 | | — | — | 50.0 | 45.0 |
| Diisodecyl phthalate | | — | — | — | 5.0 |
| AMMO¹ | | 1.0 | 1.0 | 1.0 | 1.0 |
| VTMO² | | 1.0 | 1.0 | 1.0 | 1.0 |
| DBU³ | | 0.1 | 0.1 | 0.1 | 0.1 |
| DBTDL⁴ | | 0.05 | 0.05 | 0.05 | 0.05 |
| Viscosity @ | 1 d RT | 46 | 30 | 154 | 55 |
| 20° C. | 7 d 60° C. | 50 | 32 | 232 | 97 |
| [Pa · s] | | | | | |
| HBZ | 1 d RT | 22 | 22 | 8 | 13 |
| [min] | 7 d 60° C. | 26 | 25 | 10 | 12 |
| Shore A | 7 d SCC | 47 | 54 | 57 | 56 |
| | +7 d 80° C. | 47 | 55 | 57 | 55 |
| | +14 d 80° C. | 48 | 54 | 57 | 54 |
| | +7 d 90° C. | 47 | 51 | 57 | 53 |
| | +14 d 90° C. | 45 | 48 | 57 | 50 |
| | +7 d 100° C. | 43 | 47 | 51 | 50 |

| | | | | |
|---|---|---|---|---|
| Tensile strength [MPa] | 0.60 | 0.72 | 0.76 | 0.66 |
| Elongation at break [%] | 36 | 30 | 25 | 24 |
| MoE 5% [MPa] | 1.80 | 2.69 | 3.27 | 2.77 |

¹3-Aminopropyltrimethoxysilane
²Vinyltrimethoxysilane
³1,8-Diazabicyclo[5.4.0]undec-7-ene
⁴Dibutyltin dilaurate

From Tables 1 and 2 it can be seen that the inventive compositions Z2 to Z4 and Z6 to Z9 have good to very good thermal stability, whereas comparative 5 compositions Z1 and Z5 have inadequate thermal stability. After storage at 90° C. for 14 days and at 100° C. for 7 days, the Shore A test specimens thereof have been destroyed to such an extent that measurement was no longer possible.

1. A branched polymer containing silane groups from the reaction of
(i) a polymer containing isocyanate groups and having an NCO content within a range from 0.7% to 4% by weight, obtained from the reaction of at least one monomeric diisocyanate with at least one polyether triol having an average OH functionality within a range from 2.2 to 3 and an OH value within a range from 15 to 58 mg KOH/g in a molar NCO/OH ratio of at least 1.5/1,
(ii) with at least one amino-, mercapto- or hydroxysilane,
in a stoichiometric ratio of at least 1 mol of amino-, mercapto- or hydroxysilane per molar equivalent of isocyanate groups.

2. The polymer containing silane groups as claimed in claim 1, wherein it has silane groups of formula (I) 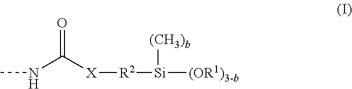
where
b is 0, 1 or 2, especially 0 or 1,
R¹ is an alkyl radical optionally containing ether groups and having 1 to 10 carbon atoms,
R² is a divalent hydrocarbyl radical having 1 to 12 carbon atoms that optionally has cyclic and/or aromatic moieties and optionally one or more heteroatoms, especially an amido, carbamate or morpholino group, and
X is O, S or NR³ where R³ is H or a monovalent hydrocarbyl radical having 1 to 20 carbon atoms that optionally has heteroatoms in the form of alkoxysilyl, ether or carboxylic ester groups.

3. The polymer containing silane groups as claimed in claim 1, wherein it has an average of 2.1 to 4 2.1 to 4 silane groups per molecule.

4. The polymer containing silane groups as claimed in claim 1, wherein the monomeric diisocyanate is 1-isocyanato-3,3,5-trimethyl-5-isocyanatomethylcyclohexane.

5. The polymer containing silane groups as claimed in claim 1, wherein the monomeric diisocyanate is diphenylmethane 4,4′-diisocyanate.

6. The polymer containing silane groups as claimed in claim 1, wherein the polyether triol, based on all repeat units, contains 80% to 100% by weight of 1,2-propyleneoxy groups and 0% to 20% by weight of 1,2-ethyleneoxy groups.

7. The polymer containing silane groups as claimed in claim 1, wherein the molar NCO/OH ratio in the reaction is within a range from 1.6/1 to 2.5/1.

8. The polymer containing silane groups as claimed in claim 1, wherein the molar NCO/OH ratio in the reaction is at least 3/1 and that after the reaction a major part of the unreacted monomeric diisocyanate is removed by means of a suitable method of separation.

9. A process for preparing a polymer containing silane groups as claimed in claim 1, wherein
(a) at least one monomeric diisocyanate is reacted with at least one polyether triol having an average OH functionality within a range from 2.2 to 3 and an OH value within a range from 15 to 58 mg KOH/g in a molar NCO/OH ratio of at least 1.5/1,
(b) a major part of the unreacted monomeric diisocyanate is then optionally removed by means of a suitable method of separation,
(c) and the resulting polymer containing isocyanate groups is then reacted with at least one amino-, mercapto- or hydroxysilane in a stoichiometric ratio of at least 1 mol of amino-, mercapto- or hydroxysilane per molar equivalent of isocyanate groups.

10. The process as claimed in claim 9, wherein at least one polyether diol is present in step a) in addition to the polyether triol.

11. A reaction product from the process as claimed in claim 9.

12. A curable composition comprising at least one polymer containing silane groups as claimed in claim 1 and at least one further constituent selected from the group consisting of catalysts, crosslinkers, adhesion promoters, desiccants, plasticizers, and fillers.

13. The curable composition as claimed in claim 12, wherein it comprises at least one further, noninventive polymer containing silane groups.

14. The curable composition as claimed in claim 12, wherein it is used as elastic adhesive or elastic sealant or elastic coating.

15. A cured composition obtained from the curable composition as claimed in claim 12 after contact thereof with moisture.
